(19) United States
(12) Patent Application Publication
(10) Pub. No.: US 2008/0047921 A1
(43) Pub. Date: Feb. 28, 2008

(54) Bottle

(75) Inventors: Victor Klabbers, Brussels (BE); Arthur Bryon Stackpole, Mason, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/825,823

(22) Filed: Jul. 9, 2007

Related U.S. Application Data
(60) Provisional application No. 60/831,140, filed on Jul. 14, 2006.

(51) Int. Cl. B65D 21/00; B23P 11/00

(52) U.S. Cl. 215/10; 29/428

(57) ABSTRACT

A bottle made of at least a first chamber and a second chamber which are produced separately and secured to each other, characterized in that at least the second chamber is nestable such that the height of two chambers when nested is from 51% to 99% of twice the height of one nestable chamber.

### CROSS REFERENCE TO RELATED APPLICATION

This application claims the benefit of U.S. Provisional Application Ser. No. 60/831,140, filed Jul. 14, 2006, the disclosure of which is incorporated by reference.

### FIELD OF THE INVENTION

The present invention relates to a bottle made of at least 2 chambers which are produced separately and secured to each other, at least one being nestable.

### BACKGROUND OF THE INVENTION

Bottles with multi-compartments are well known in the art and can be produced by different methods: The compartments can be produced simultaneously or separately and then affixed together.

In the field of air fresheners, please refer for example to WO2005/123154 disclosing air fresheners units for use on bottles and in particular air fresheners units for use on the upper part of a bottle where such units comprise 2 sections, one being a closure for another section. WO02/078750 discloses an air freshening unit comprising a primary bottle and a refill bottle dimensioned so as to abut closely with and interlock with the primary bottle. WO02/20172 published by Fresh Product on Mar. 14, 2002 discloses a combined unit wherein the air freshener may be passively dispersed at a controlled rate or actively dispersed when a user pumps the apparatus to receive a measured quantity of hand lotion.

The object of the present invention is to provide a multi-compartment bottle which is easy and economical to produce. The invention is directed to a bottle made of at least 2 chambers, at least one chamber being nestable. It has been found that for an economical and fast production of such bottles when the chambers are produced separately and must be assembled within the production line, it is important that the at least one of the chamber is nestable so that it can fit compactly within one another. Indeed, the nesting of the chambers will provide volume reduction during transport and storage; easy handling of large quantities by forming stacks; and easy dosing and positioning on a production line.

### SUMMARY OF THE INVENTION

The present invention relates to bottle made of at least 2 chambers which are produced separately and secured to each other, at least one chamber being nestable and configured such that the height of two chambers when nested is from 51% to 99%, preferably from 52% to 85%, more preferably from 55% to 75% of twice the height of one chamber.

In a preferred embodiment, the bottle will be made of an upper chamber and a lower chamber, with preferably the lower chamber being nestable.

In another preferred embodiment, the chambers of the bottle will comprise a household product with preferably the first chamber will comprise a first household product, preferably being a hand dishwashing liquid product and the second chamber will comprise second household product, preferably an air freshening product.

The present invention also relates to processes for making such products.

### BRIEF DESCRIPTION OF THE FIGURES

The preferred embodiments of the invention are disclosed in more detail in reference to FIG. 1 and FIG. 2.

FIG. 1 illustrates a perspective view of a stack of nested chambers.

FIG. 2 illustrates a perspective view of a bottle with an upper chamber and a lower nestable chamber.

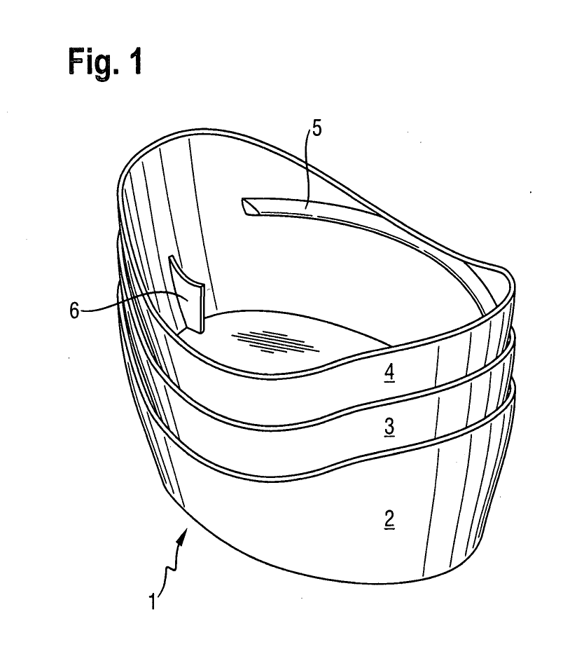

FIG. 1 depicts a stack (1) of nested chambers (2) to (4) with a snap bead (5) and a spacer (6).

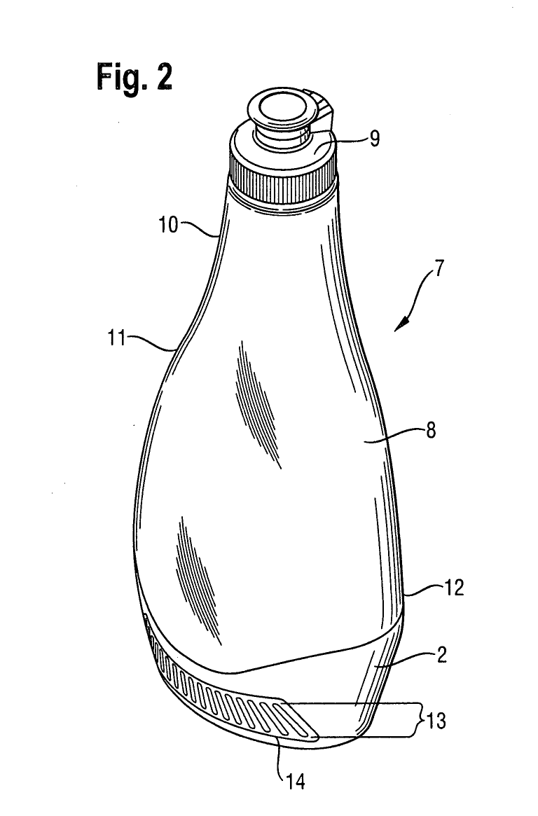

FIG. 2 depicts: A bottle (1) comprising a first upper chamber (2) with a flip-top cap as a closure (3) and a lower second nestable chamber (4). The upper chamber has a neck (5) and a grip area (6) preferably a squeeze area and a base (7). The lower nestable chamber (4) is attached to the base of the upper chamber (7) via for example groove(s). The lower nestable chamber is an air freshener unit (4) with a venting area (8). Such venting area is closed by a removable sticker (9).

### DETAILED DESCRIPTION OF THE INVENTION

The present invention is directed to a bottle made of at least 2 chambers which are produced separately and can be permanently or detachably secured to each other. At least one of such chambers (second chamber) is configured such that the height of two second chambers when nested is from 51% to 99%, preferably from 52% to 85%, more preferably from 55% to 75% of twice the height of one second chamber.

A “chamber” shall mean an enclosed space forming a compartment of the bottle. It can be enclosed via a closure such as a cap or such as the second chamber, closing said first chamber.

The nestable chamber will be configured such that one chamber can fit compactly within one another to form a sequence with each chamber contained in or containing the next. Therefore, the nestable chamber will comprise a horizontal bottom and a vertical wall with an inclination sufficient to allow another nestable chamber to fit into. The inclination and the thickness of the vertical wall(s) will determine how deep will one chamber fit into the other. The inclination angle and thickness of the vertical wall(s) will be such that the other nestable chamber will enter the first nestable chamber so that the height of two nestable chambers when nested is from 51% to 99%, preferably from 52% to 85%, more preferably from 53% to 75% of twice the height of one nestable chamber. The horizontal bottom can be of any shape such as circular, oval or rectangular. The vertical walls can be of any form such one conical continuous wall or can be made of several walls.

In a preferred embodiment, the nestable chamber can further comprise spacers such as one or more rib(s). Spacers will allow the nestable chambers to form more stable stacks for improved manual or automatic handling of the stack. Spacers will also provide improved denesting of the chambers from the denesting equipment during production.

In a preferred embodiment, the nestable chamber will be configured as depicted in FIG. 1 wherein the horizontal bottom is oval, the vertical wall is a continuous conical wall and comprise side ribs.

The chambers can be of any material including glass, but plastics are preferred and in particular plastic that can be injection molded or blowmolded. These include polyolefins such as polypropylene and polyesters such as polyethylene terephtalate.

### Upper-Lower Chamber

In a preferred embodiment, the bottle will be made of an upper chamber and a lower chamber. Each of or both of such chambers can be nestable but preferably, the lower chamber will be the nestable chamber of the present invention.

Preferably, the upper chamber will be closed by a closure. The closure can be of any material described above for the chambers. Any shape can be used for the upper chamber body of the present invention and will typically comprise a neck closed by a closure, a grip area, preferably a squeeze area and a base. The neck can be closed by any cap, preferably a flip-top cap or pull and push cap, more preferably a flip-top cap.

The nestable chamber—preferably lower chamber—will be produced separately and can be permanently or detachably secured to the second chamber—preferably upper chamber. The nestable chamber can be fixed to the other chamber via for example a clip-on system. The nestable chamber can be of any shape and will preferably be in the form of a cup when serving as a receiving base for the upper chamber.

### Compositions

In a preferred embodiment, the chambers of the bottle will comprise a body care and/or household product, more preferably a household product. Preferably the first chamber will comprise a first body care and/or household product and the second chamber will comprise a second body care and/or household product.

In a more preferred embodiment, the upper first chamber will comprise a first household product and the nestable lower second chamber will comprise a second household product.

Preferably, the composition of the first chamber will be the same color as or will match the color or color shade of the composition of the second chamber.

Preferably, the first chamber will comprise a pourable detergent composition, preferably a liquid detergent composition dispensible from the bottle by pouring or squeezing the detergent composition. Such detergent composition is typically selected from the group of a dishwashing composition, a laundry composition, and/or a hard surface cleaning composition, and preferably is a hand dishwashing composition. Such detergent composition usually includes a surfactant system, and typically a solvent, and one or more optional ingredients known in the art of cleaning such as a polymer, a dye, an enzyme, a perfume, a thickener, a pH controlling agent, a reducing or oxidizing bleach, an odor control agent, antioxidants and free radical inhibitors, and a mixture thereof.

Preferably, the second chamber will comprise an air freshening composition. While the description which follows frequently refers to an air freshener or fragrancing application, it is to be understood that the invention is also applicable to other forms of dispersible materials which may be dispensed passively such as deodorizers, odor eliminators, malodor counteractants, insecticides, insect repellant, medicinal substances, disinfectants, sanitizers, mood enhancers, and aroma therapy compositions.

### Lower Chamber with Air Freshening Composition

When the second chamber comprise an air freshening composition (thereafter referred to as air freshening unit of AF unit), it must be constructed such as to ensure that the fragrance can diffuse outside. The AF unit can therefore be made of a material which is, as such, permeable to perfumes, for instance low density polyethylene and preferably is made of any plastic, and comprises openings also referred to as vents, allowing communication of the fragrance from the AF unit headspace to the outside environment. These opening(s) or vent(s) form all together the venting area and can be in whatever shape and orientation. Before use, the venting area of the AF unit will be sealed with any means such as with removable sticker(s) or shrink sleeve. Such seal can be in one or more pieces so as to allow the adjustment of the air freshener's release by e.g. removing one, several or all stickers.

### Air Freshening Composition

Typically, an ingredient suitable for inclusion in the air freshener unit is a fragrance, air freshener, deodorizer, odor eliminator, malodor counteractant, insecticide, insect repellant, medicinal substance, disinfectant, sanitizer, mood enhancer, aroma therapy composition, or the like, in solid, liquid or gel form.

A liquid fragrance may also be formed into a thixotropic gel by the addition of a thickening agent, such as a cellulosic material, a polymeric thickener, or a fumed silica of the type marketed under the Cabosil trademark by Cabot Corporation. A fragrance ingredient can also be in the form of a crystalline solid, which has the ability to sublime into the vapor phase at ambient temperatures. In a preferred embodiment, the air freshener composition is in the form of perfumed particles which emit their perfume gradually over time. Particles suitable for use herein may be made of polymers, or clay, or porous rocks or stones such as pumice, silica or silicates, aluminas and aluminosilicates such as zeolite. Suitable perfumed particles for use herein are commercially available from International Flavors and Fragrances (IFF) under the trade-name Polyiff. Such particles are available as both low density polyethylene and as ethylene vinyl acetate (EVA) and are preferably the EVA form.

Preferably the fragrance of the air freshener will be coordinated or will be the same as the perfume accord of the detergent composition.

### Process of Making

The bottle of the present invention can be produced by any process chosen by the person skilled in the art. The chambers can be produced from any plastic material by injection moulding or blow moulding. The plastic material can be polyolefins such as polypropylene and polyesters such as polyethylene terephtalate. In a preferred embodiment, the first chamber is an upper chamber produced from polyethylene terephtalate via stretch blow moulding. The second chamber is the nestable chamber and is a lower chamber, which is separately produced from polypropylene via injection moulding. If produced in a separate plant, when the nestable chamber arrives in the assembly plant, the second nestable chamber would need to be unpacked from cases and be dosed on the line. If produced in the same plant but in another production line, the second nestable chambers need to be as well dosed on the line via a denesting unit by gravity or vacuum, section or mechanical transaction, preferably by gravity. The second nestable chambers need to be correctly oriented on the line in order to allow proper automatic assembly to the first upper chamber to make the bottles. On the line, the upper chambers will be positioned above the cups and automatically pressed onto the cups.

In the present invention, the second chambers are indeed nested. Hence, the second nestable chambers can be manually taken out of the cases in stacks. The stacks allow easily manually handling of large quantities of chambers in limited time. The second nestable chambers can subsequently be placed in denesting tubes to allow easy dosing such as simply gravity dosing, onto the conveyor belt. When the second chambers are not nested, they would need to be dosed onto the line via an ‘unscrambler’. This is an expensive and large piece of equipment. The unscrambler would collect and orient the second chamber and dose them onto the line. Therefore, it has been found that the second nestable chambers of the present invention allow significant capital avoidance: no need to purchase unscrambler equipment, and space saving.

The two chambers can either be assembled manually or automatically by clicking the two chambers together. For example, the chambers will snap together (the snap bead of the lower chamber will snap into the groove on the upper chamber).

Hence, the bottle of the present invention is made from the following steps:
(1) The second chamber is inserted in the denesting unit;
(2) The second chamber is dosed from the denesting unit, preferably by gravity, and positioned on the conveyor belt;
(3) The first chamber is positioned over the second chamber; and
(4) The first chamber and second chambers are pressed and assembled.

In a further embodiment, the bottle comprises two nestable chambers wherein both chambers are inserted in and dosed from denesting units.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for making a bottle made of at least a first chamber and a second chamber, wherein the at least second chamber is configured such that the height of two chambers when nested is from about 51% to about 99%, of twice the height of one second chamber;
comprising the following steps:
(i) inserting the second chamber in a denesting unit;
(ii) dosing the second chamber from the denesting unit on a conveyor belt;
(iii) positioning the first chamber over the second chamber; and
(iv) assembling the second chamber and first chamber by pressure.

2. A method for making a bottle according to claim 1 wherein the at least second chamber of the bottle is configured such that the height of two chambers when nested is from about 52% to about 85% of twice the height of one second chamber.

3. A method for making a bottle according to claim 2 wherein the at least second chamber of the bottle is configured such that the height of two chambers when nested is from about 55% to about 75% of twice the height of one second chamber.

4. A method for making a bottle according to claim 1 wherein the first chamber of the bottle is an upper chamber and the second chamber is a lower chamber.

5. A method for making a bottle according to claim 1 wherein the chambers of the bottle comprise a body care or household product.

6. A method for making a bottle according to claim 5 wherein the chambers of the bottle comprise a household product.

7. A method for making a bottle according to claim 1 wherein the first chamber of the bottle will comprise a first body care and household product and the second chamber will comprise a second body care and household product.

8. A method for making a bottle according to claim 4 wherein the first chamber of the bottle will comprise a detergent product, preferably a dishwashing product.

9. A method for making a bottle according to claim 8 wherein the second chamber of the bottle will comprise an air freshening composition.

10. A method for making a bottle according to claim 9 wherein the air freshening composition comprises air freshener in form of perfume particles.

11. A method for making a bottle according to claim 1 wherein the second chamber of the bottle further comprises a spacer.

12. A method for making a bottle according to claim 1 wherein the second chamber of the bottle is dosed from the denesting unit on a conveyor belt by gravity.
